(19) United States
(12) Patent Application Publication
(10) Pub. No.: US 2026/0067187 A1
(43) Pub. Date: Mar. 5, 2026

(54) LOW LATENCY GATEWAY SERVICE FOR ASYNCHRONOUS HANDLING OF DATA PROCESSING REQUESTS WITH DOWNSTREAM COMPUTING SERVICES

(71) Applicant: PAYPAL, INC., San Jose, CA (US)

(72) Inventors: Prabin Patodia, Bangalore (IN); Rajendra Bhat, Bangalore Urban (IN); Shivam Jari, Bengaluru (IN)

(21) Appl. No.: 18/824,480

(22) Filed: Sep. 4, 2024

(51) Int. Cl. H04L 43/06; H04L 43/0888

(52) U.S. Cl. CPC H04L 43/06; H04L 43/0888

(57) ABSTRACT

There are provided systems and methods for a low latency gateway service for asynchronous handling of data processing requests with downstream computing services. A service provider, such as an electronic transaction processor for digital transactions, may utilize different computing services that implement rules and artificial intelligence models for decision-making of data including data in production computing environment. In this regard, the service provider may utilize an API gateway at gateway decision services to assist with execution of workflows to schedule and process tasks with downstream computing services. The API gateway may asynchronously call the downstream services based on the workflow so that responses can be obtained quickly and without introducing latency based on different response times. The API gateway may utilize the workflows that are highly configurable so that new decision services and changes to decision services may be introduced with minimal service disruptions.

### TECHNICAL FIELD

The present application generally relates to gateway computing services for enterprise computing systems, and more particularly to providing an application programming interface (API) gateway for asynchronous calls to downstream computing services using executable workflows.

### BACKGROUND

Online service providers may offer various services to end users, merchants, and other entities. This may include providing electronic transaction processing data flows, services, and other computing resources. Further, the service provider may provide and/or facilitate the use of online merchant marketplaces and/or transaction processing between different entities. When providing these computing services, the service provider may utilize various processes, which may correspond to decision services, micro-computing services, and other components of an application and system architecture that include rules-based and/or machine learning (ML)-based engines, computing nodes, execution paths, and the like to process data requests. Generally, requests from clients and computing devices of users may be received at a gateway service that acts as an entry point for a group of services, where the gateway service may be responsible for orchestrating and calling all the dependent services that are invoked for a specific request.

For example, a risk analysis and engineering platform may provide capabilities to create trusted experiences for merchants, consumers, and partners. As the risk platform evolves over time to provide customized fraud management solutions, many risk solutions and services may be created to provide the decisioning capability. For each user flow/activity like login, onboarding, adding of funding instruments, making a payment, etc., calls by an API gateway to multiple risk downstream services (e.g., microservices) may be made to check whether the flow/activity being performed is fraudulent or not. As such, when the collection of microservices expands, interconnections become complex and require auto-managed orchestration and/or consolidation. Further, the API gateway should have as low latency as possible to provide real-time fraud detection and other computing services, where quick response times are needed or desired, such as to more quickly detect and address fraud, enhance user satisfaction, and the like. As such, it is desirable to provide a streamlined solution to API gateway calls to downstream services to reduce the calls and latency involved with each service.

### BRIEF DESCRIPTION OF THE DRAWINGS

FIG. 1 is a block diagram of a networked system suitable for implementing the processes described herein, according to an embodiment;

FIG. 2 is an exemplary system environment where a gateway of a service provider may provide asynchronous handling of data processing requests using predefined workflows, according to an embodiment;

FIGS. 3A-3C are exemplary diagrams for processing of requests using asynchronous calls by a gateway service to downstream computing services, according to an embodiment;

FIG. 4 is a flowchart of an exemplary process for a low latency gateway service for asynchronous handling of data processing requests with downstream computing services, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for a low latency gateway service for asynchronous handling of data processing requests with downstream computing services. Systems suitable for practicing methods of the present disclosure are also provided.

A user may utilize a client to interact with an online service provider, such as by using a computing device with an application or website to interact with a computing architecture and the different computing services of the application, platform, and system of the service provider. A service provider may provide different computing resources and services to users through different websites, resident applications (e.g., which may reside locally on a computing device), and/or other online platforms. When utilizing the services of a particular service provider, the service provider may provide decision services for implementing rules and intelligent decision-making operations with such services. Decisions services (e.g., microservices and/or other computing services for an application and computing architecture for one or more digital platforms and/or systems of the service provider) may, for example with an online transaction processor, provide services associated with electronic transaction processing, including account services, user authentication and verification, digital payments, risk analysis and compliance, and the like. These services may further implement automated and intelligent decision-making operations and engines, including data processing rule engines that automate decision-making based on rules designated for the systems.

As such, decision services may be used for risk analysis, fraud detection, and the like to determine if, when, and how a particular service may be provided to users. For example, risk rules may be utilized with a risk engine for a decision service to determine if an indication of fraud is present in a digital transaction or payment, and therefore to determine whether to proceed with processing the transaction or instead decline the transaction (as well as additional operations, such as request further authentication and/or information for better risk analysis). The user may provide data for a request, directly or indirectly, to be processed, such as by creating, transmitting, and/or providing a data processing request to perform an activity, process data, and/or receive a response from the service provider's computing system and/or application(s). This may require use of different computing services, applications, and layers of the service provider. Processing of a request and the used services may be based on request and/or response specification of the computing architecture. The service provider may utilize a gateway service that may be called by external applications, websites, services, and platforms of external entities, third-parties, merchants, customers, and the like when the other decision services, or downstream services are required and/or used for data processing.

As such, when clients (e.g., computing devices of users) connect with and/or call computing services of service providers, decision services may be invoked to process a particular request, call, or the like by a gateway service, which may process data using workflows and an API gateway. For example, a user may utilize online service providers, such as transaction processors, via their available online and networked platforms. A user may make a payment to another user or otherwise transfer funds using the online platforms of the service providers. In this regard, a user may wish to process a transaction, such as for a payment to another user or a transfer. A user may pay for one or more transactions using a digital wallet or other account with an online service provider or transaction processor (e.g., PayPal®). An account may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The account and/or digital wallet may be loaded with funds or funds may otherwise be added to the account or digital wallet. The application or website of the service provider, such as PayPal® or other online payment provider, may provide payments and the other transaction processing services via the account and/or digital wallet.

Once the account and/or digital wallet of the user is established, the user may utilize the account via one or more computing devices, such as a personal computer, tablet computer, mobile smart phone, or the like. The user may engage in one or more transactions with a recipient, such as a recipient account or digital wallet that may receive an amount of a payment. When engaging in these interactions, the service provider may provide microservices and/or decision services that may be used to process data requests and provide a decision or other output, which may be used in conjunction to provide computing services to users. Services may include gateway services for incoming requests, as well as corresponding downstream processing services. However, downstream processing services may be continually updated, changed, added, and/or removed, which adds complexity to the service provider's computing system and architecture, and further creates difficulties in maintaining a gateway service that provides low latency and high flexibility for updating and configuring. As such, the service provider may utilize an application programming interface (API) gateway that may be called to execute workflows for asynchronous calling of downstream services.

In particular, constantly integrating new components may become tedious and introduce latency, errors, and other issues with gateway services. As such, in one embodiment, a service provider may provide a streamlined solution through an API gateway that orchestrates the calls to downstream services using predefined workflows and intelligent execution. Different gateway services may then consolidate their interactions into a single call to the API gateway, eliminating the need for multiple direct calls to downstream services. The API gateway therefore becomes a gateway for entry to the host of computing, decision, and/or micro services of the service provider that are abstracted behind the gateway service. However, with requests from clients, this introduces an additional hop and service level agreement (SLA) time consumption for obtaining responses from the same downstream services, as well as computing cost and maintenance needed to maintain the gateway. As such, the service provider may utilize predefined executable workflows at the API gateway to process requests with as low of a latency as possible, and with as high of a throughput as possible. This further allows the API gateway to be highly configuration-driven.

To handle many concurrent connections with gateway services, the API gateway may accept those connections without delay and with a minimal use of resources. When a new request is received, a new channel is created specifically for that request. The channel represents the connection between two entities (e.g., the client and the server) and is attached to an event loop. As such, any network event to the server may be detected by the event loop and is assigned to a channel for further handling. The behavior of each channel, such as buffer size, timeouts, and other settings, may be fined tuned to allow for optimal configuration for specific use cases and efficient resource utilization. Further, to handle these network events in each channel concurrently, a workflow-based approach may be used, which allows responses from the decision services (e.g., with a decision or other result of data processing) to be performed within the agreed SLA.

For example, orchestrating multiple downstream calls for a high volume of concurrent requests in a synchronous fashion may lead to huge thread contention between processing threads for each request and event, which causes memory issues and impacted latency. As such, an orchestration engine may utilize a directed acyclic graph (DAG)-based workflow processor and engine, or another directed graph processor, with the ability to dynamically manage timeouts. This provides an asynchronous and event-based orchestration engine that can orchestrate the calls with a minimal number of threads, low memory consumption, and low latency. The workflow for each API endpoint may be predefined in a configuration file, which designates the different calls to the different services to be executed to handle and process a request. This workflow, when executed, provides a resulting response, decision, or output from the downstream services that is responsive to the request. The workflows may be parsed and prepared during startup of the gateway application and service to mitigate additional computational overhead of parsing upon receiving a request. When a request is received at the gateway service endpoint for one or more particular downstream service(s) and API, the predefined workflow for the endpoint is fetched from the application context to the request for execution by the API gateway. Each workflow is executed by an execution engine component at the API gateway in a reactive manner to the incoming request. The DAG or another directed graph of the workflow may include data processing nodes where the execution engine at the API gateway schedules execution of the nodes of the workflow in an asynchronous manner. This asynchronous manner may include processing each separate node and/or branch of nodes without requiring waiting for a response from the downstream service(s) from executing and/or processing other ones of the nodes and/or branches.

The response of the nodes, when executed, may be handled using a reactive approach as specified by the reactive stream specification of the execution engine. The task scheduling algorithm of an execution engine uses graph traversal and stores all the responses from node execution returned for each scheduled task (e.g., node execution task scheduled asynchronously). As such, the API gateway may avoid waiting for the response from downstream services before further execution, and the processing thread is free to take other tasks. As soon as a response from a downstream service becomes available, the API gateway may determine if a response to the request is completed and/or may be determined for response to the client. The workflow may utilize predefined nodes for common use cases such as invoking downstream services, publishing messages, error handling, logging, filtering etc., as well as flexibility and capability to incorporate customized nodes that implement custom logic. As such, if the downstream service undergoes changes or a new version becomes available, users may seamlessly transition to the updated service through node reconfiguring and updating. Further, the API gateway may utilize a key performance indicator (KPI) monitor such that downtimes and impacts to availability of the API gateway may be closely monitored. Among the KPIs that may be monitored are gateway availability to business (ATB) values, latency, and throughput of the gateway. The monitor may capture and/or record logs to sample these metrics and detect leaks, slowdowns, or availability issues. As such, the service provider may ensure the API gateway meets the expected standards of an SLA and promptness in delivering services to clients.

In this manner, a service provider may provide more efficient handling and processing of data processing requests and data loads between computing services and other decisioning operations for a data processing system. The API gateway and predefined workflows executed by an execution engine may be configuration-driven by data processing requests and downstream decision services so that client requests may be handled in a faster and more specific manner. As such, the API gateway may allow for a more flexible framework where downstream services may be customized, updated, and changed while allowing for minimal gateway disruptions and changes, resulting in faster and more accuracy handling of data processing results, as well as confidence and reliability when adding or changing decision services. This allows for a more efficient gateway service that handles requests with lower latency than conventional systems and services.

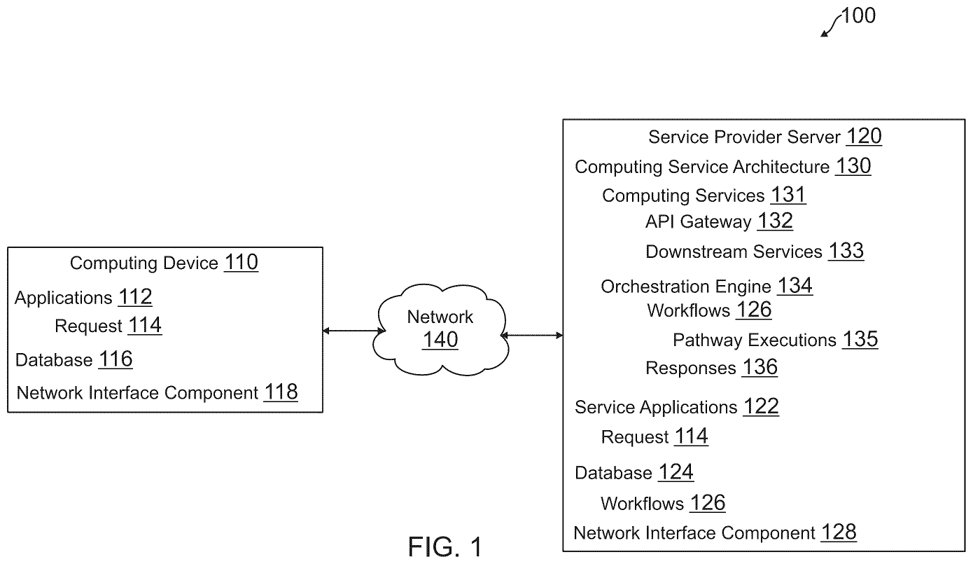

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a computing device 110 and a service provider system 120 in communication over a network 140. Computing device 110 may be utilized by a user to access a computing service or resource provided by service provider system 120, where service provider system 120 may provide various data, operations, and other functions to computing device 110 via network 140 including those associated with applications and computing infrastructures that utilize decision and other computing services for decision-making and data processing. In this regard, computing device 110 may be used to access a website, application, or other platform that provides computing services. Service provider system 120 may provide computing services that process data and provide decisions in response to data processing requests via computing services, where service provider system 120 may provide an API gateway with gateway computing services to more efficiently coordinate calls to decision services and provide responses to requests for computing device 110 and other clients.

Computing device 110 and service provider system 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Computing device 110 may be implemented as a communication device that may utilize appropriate hardware and software configured for wired and/or wireless communication with service provider system 120 and/or other devices or servers. For example, in one embodiment, computing device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Computing device 110 of FIG. 1 contains an application 112, a database 116, and a network interface component 118. Application 112 may correspond to executable processes, procedures, and/or applications with associated hardware. In other embodiments, computing device 110 may include additional or different modules having specialized hardware and/or software as required.

Application 112 may correspond to one or more processes to execute software modules and associated components of computing device 110 to provide features, services, and other operations for a user over network 140, which may include accessing and utilizing computing services provided by service provider system 120 including transmitting or providing a request 114, directly or indirectly (e.g., not a specific request, but an action that implies a request or otherwise indicates a response is needed for the action), to service provider system 120 for processing by service provider system 120. In this regard, application 112 may correspond to specialized software utilized by computing device 110 to access a website or application (e.g., mobile application, rich Internet application, or resident software application) that may display one or more user interfaces that allow for interaction with the computing services of service provider system 120. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other embodiments, application 112 may include a dedicated application of service provider system 120 or other entity.

Application 112 may be associated with account information, user financial information, and/or transaction histories. However, different services may be provided via application 112, including social networking, media posting or sharing, microblogging, data browsing and searching, online shopping, and other services available through service provider system 120. Thus, application 112 may also correspond to different service applications and the like. When utilizing application 112 with service provider system 120, application 112 may request processing of a data processing request, such as by transmitting or providing request 114 for processing and/or providing data with request 114 to process the data and/or return a data processing result when utilizing one or more computing services of service provider system 120. Request 114 may correspond to account login, authentication, electronic transaction processing, and/or use of other services described herein. Request 114 may correspond to request code and/or have a corresponding data load that is processed via one or more decision services of service provider system 120 to provide a decision that is used to provide a resulting output and result. As such, application 112 may be used with the decision services of service provider system 120. In this regard, service provider server 120 may provide an API with gateway computing services to respond to request 114 and other clients and client requests, as discussed herein.

Computing device 110 may include other applications as may be desired in particular embodiments to provide features to computing device 110. For example, these other applications may include security applications for implementing client-side security features, programmatic client applications for interfacing with appropriate API over network 140, or other types of applications. Other applications on computing device 110 may also include email, texting, voice and IM applications that allow a user to send and receive emails, calls, texts, and other notifications through network 140. In various embodiments, the other applications may include financial applications, such as banking applications. Other applications may include social networking applications, media viewing, and/or merchant applications.

The other applications may also include location detection applications, which may be used to determine a location for the user, such as a mapping, compass, and/or GPS application, which can include a specialized GPS receiver that determines location information for computing device 110. The other applications may include device interface applications and other display modules that may receive input from the user and/or output information to the user. For example, computing device 110 may contain software programs, executable by a processor, including a graphical user interface (GUI) configured to provide an interface to the user. The other applications may therefore use devices of computing device 110, such as display devices capable of displaying information to users and other output devices, including speakers.

Computing device 110 may further include database 116 stored on a transitory and/or non-transitory memory of computing device 110, which may store various applications and data and be utilized during execution of various modules of computing device 110. Database 116 may include, for example, identifiers such as operating system registry entries, cookies associated with application 112 and/or other applications, identifiers associated with hardware of computing device 110, or other appropriate identifiers, such as identifiers used for payment/user/device authentication or identification, which may be communicated as identifying the user/computing device 110 to service provider system 120. Moreover, database 116 may include data used for request 114, such as data that may be provided to service provider system 120 for processing request 114.

Computing device 110 includes at least one network interface component 118 adapted to communicate with service provider system 120 and/or another device or server. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider system 120 may be maintained, for example, by an online service provider, which may provide computing services that utilize decision and microservices for decision-making in an intelligent system to provide responses, output, and/or results to computing device 110 and other clients, devices, servers, and the like. In this regard, service provider system 120 includes one or more processing applications which may be configured to interact with computing device 110 for data processing. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes a computing service architecture 130 having computing services 131 and an orchestration engine 134, service applications 122, a database 124, and a network interface component 128. Computing services 131, orchestration engine 134, and service applications 122 may correspond to executable processes, procedures, and/or applications with associated hardware. In other embodiments, service provider system 120 may include additional or different modules having specialized hardware and/or software as required.

Computing service architecture 130 of service provider system 120 may correspond to a framework, platform, or device/server system that may provide service applications 122 usable by customers and other users over network 140 for data processing and other online activities. In this regard, computing service architecture 130 includes computing services 131 that may correspond to the different decision, micro, and/or data processing services utilized by service applications 122 and/or provided to clients. Computing services 131 may be called during processing of different data processing requests, for example, to provide a result or output used in the processing of the request and return of a response to a client. The clients may correspond to different ones of service applications 122 that may be invoked by computing device 110 for use, such as to process transactions electronically, create and/or utilize a digital account, and the like. For example, computing services 131 may include gateway computing services, which may correspond to entry to “gateway” decision and/or micro services that handle incoming requests from clients, internal and/or external devices (e.g., computing device 110), servers, and the like. Gateway services may route such requests and/or schedule/assign tasks for processing those requests with downstream services 133 that may provide real-time, batch, or other processing task and job execution for different requested computing operations and services (e.g., risk decisioning, fraud detection, authentication, transaction processing, compliance, messaging, etc.).

Computing services 131 may correspond to those used in the provision of service applications 122 to users, which may utilize the decision services, microservices, and the like provided through computing services 131 for real-time decisioning, data processing, and other computing operations provided by service applications 122. For example, computing services 131 may include gateway computing services that may be utilized to handle and orchestrate the processing of incoming data processing requests, such as request 114 from computing device 110. The gateway services may be associated with an API gateway 132 that may act as an inter-service communication gateway at an internal domain level. API gateway 132 may facilitate orchestration of calls to multiple ones of downstream services 133 based on their configuration, as well as response consolidation using configurable consolidation tables to identify the response received and then to be sent to the original caller and/or client. When API gateway 132 calls multiple services that return different errors, API gateway 132 may utilize custom configured rules for sending errors back upstream to the caller and/or client. API gateway 132 may allow for changing and/or updating from old versions to new versions of services or migrating to a new downstream service seamlessly by allowing reconfiguring of data processing nodes and calls to be made in a simplified manner. Further, API gateway 132 may have a capability to provide partial responses and fallback if one or more of downstream services 133 are not responding. A monitoring operation and/or application for API gateway 132 may perform logging of requests and responses, as well as other parameters, for debugging, and publishing of messages and events. API gateway 132 may be used as proxy service for other services and gateways.

The gateway services may correspond to an orchestration layer or set of orchestrating services that utilize API gateway 132 to manage routing and/or transmission of requests and other data to downstream services 133 for handling and processing of data processing requests, as well as use of service applications 122 by clients. Together, API gateway 132 and downstream services 133 may be used for different computing operations with merchant and/or customers and their devices, such as a login operation, an authentication operation, an electronic transaction processing, a risk analysis, or a fraud detection. As such, service applications 122 may correspond to the software applications, websites, operations, platforms, and the like accessed and/or utilized through computing services 131 (as well as including computing services 131, where applicable) used by different clients, such as for a mobile transaction processing application (e.g., using authentication, risk and fraud, account, payment or transfer, etc., services), a web application for account login and digital wallet, a social payments application, a social media platform application, and the like. Execution and use of computing services 131 for service applications 122 may be performed by orchestration engine 134 when initiated and/or invoked by API gateway 132, which may make asynchronous calls to downstream services 133 based on workflows 126.

Orchestration engine 134 may correspond to a digital platform, software application and/or application architecture, or the like that may include one or more processes that execute modules and associated specialized hardware of service provider system 120 to provide handling of data processing requests through API gateway 132 to allow for a customizable and configuration-driven gateway with low latency and high processing efficiency. In this regard, orchestration engine 134 may correspond to specialized hardware and/or software that may be created and deployed for execution during run-time and/or with a live production computing environment for providing efficient handling of data processing requests through API gateway 132, such as during use of computing services 131 by service applications 122 for handling for data processing requests 124 and the like. As such, orchestration engine 134 may execute workflows 126 by processing different data processing nodes in pathways through pathway executions 135 to receive responses 136 from downstream services 133. Pathway executions 135 may call downstream services 133 based on the specification and parameters of workflows 126 asynchronously without waiting for responses and/or without having to sequentially call different services, such as by calling downstream services 133 when available, so that responses 136 may be received asynchronously and as fast as possible for responding to data processing requests quickly, efficiently, and with low latency.

In this regard, workflows 126 may include data processing nodes that are associated with computing tasks, jobs, or executable code/processes for downstream services 133 to perform or execute and provide a response, such as a request validation node, authentication node, risk modeling or analysis node, balance check node, balance transfer or payment processing node, etc. These computing tasks in workflows 126 may be executed in an order and/or processing flow according to a directed acyclic graph (DAG) or another directed graph or ordering of the computing tasks for execution by downstream services 133 when invoked by orchestration engine 134 for processing a request being handled by API gateway 132. For example, a DAG or other graph may correspond to a flow of computing tasks that causes output of a decision. Computing tasks may be arranged in an order within a DAG depending on the decision service and/or data processing request, for example, in branches or pathways so that certain computing tasks may execute and provide data for processing. The directed graph may correspond to pathways and/or an execution flow, and workflows 126 may have different execution paths for executing the computing tasks in series, parallel, or the like. This may include having nodes for computing tasks connected by edges to show the various paths (e.g., in series, parallel, start, end, etc.) for the execution flow. As such, when workflows 126 are executed by asynchronously performing pathway executions 135, responses 136 may be received from the corresponding decision service, which may be used when responding to requests from devices.

In some embodiments, orchestration engine 134 may implement AI models, such as ML or neural network (NN) models, rule engines, large language models (LLMs), and the like, for intelligent execution of workflows 126 and/or asynchronous calling of downstream services 133. AI models utilized by orchestration engine 134 may be invoked when handling requests to intelligently determine which calls can be executed asynchronously. The AI models may also be used to determine how to handle received responses from downstream services based on execution of workflows 126 and how to respond to request 114 and other data processing requests from clients based on those responses. AI models may generally correspond to any artificial intelligence that performs decision-making, such as rules-based engines and the like. However, AI models may also include subcategories, including ML models and NN models that instead provide intelligent decision-making using algorithmic relationships. Generally, ML models may include deep learning models, decision trees, clustering algorithms and the like, and may correspond to a subset of ML models that attempt to mimic human thinking by utilizing an assortment of different algorithms to model data through different graphs of neurons, clusters, trees, and the like. Some ML models may include nodes of data representations based on the algorithms that may interconnect different nodes using mathematical relationships. ML models may encompass NNs and other models that may similarly utilize one or more mathematical algorithms to similarly generate layers, trees, clusters, and/or correlations to make intelligent decisions on input data.

When building or training ML model, training data may be used to generate one or more classifiers and provide recommendations, predictions, or other outputs based on those classifications and an ML model. The training data may be used to determine input features for generating predictive scores for data derivations, such as what data may be inferred or assumed from known data and/or actually available data, and what data may not be inferred or assumed. For example, ML models may include one or more layers, including an input layer, a hidden layer, and an output layer having one or more nodes; however, different layers may also be utilized. As many hidden layers as necessary or appropriate may be utilized. Each node within a layer is connected to a node within an adjacent layer, where a set of input values may be used to generate one or more output scores or classifications. Within the input layer, each node may correspond to a distinct input feature, attribute, or input data type that is used to train the ML model, where output nodes may correspond to output classifications and the like.

Thereafter, the hidden layer may be trained with these attributes and corresponding weights using an ML algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values that attempt to classify or provide a predictive output from input data. Thus, when an ML model is used to perform a predictive analysis and output, the input may provide a corresponding output based on the classifications trained for the ML model.

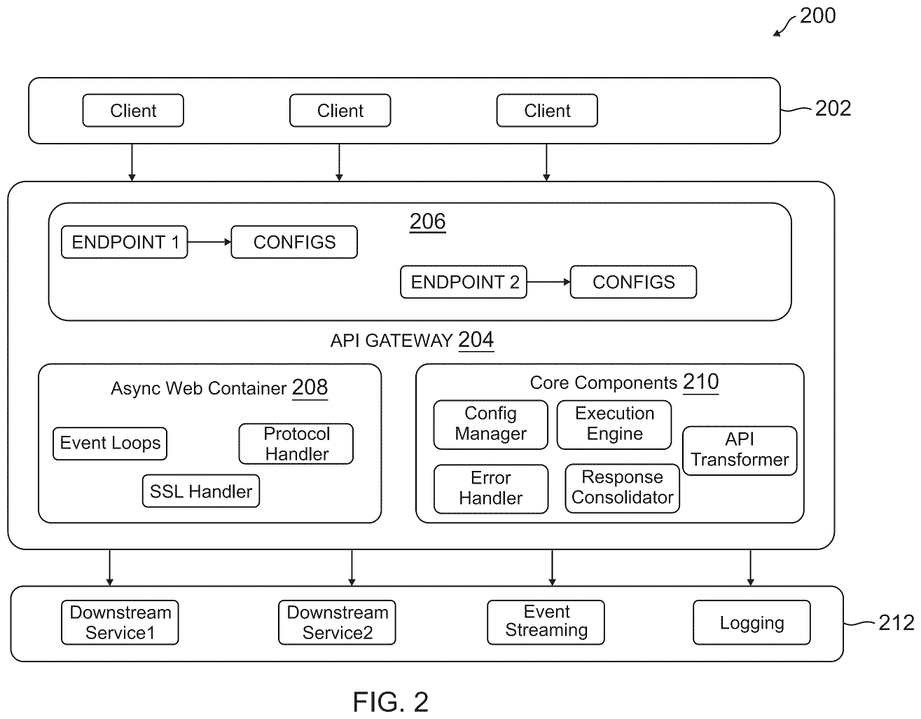

ML models may be trained by using training data associated with past known and/or derived data. By providing training data to train the ML model, the nodes in the hidden layer may be trained (adjusted) such that an optimal output (e.g., a classification within an accuracy threshold) is produced in the output layer based on the training data. By continuously providing different sets of training data, and with NNs penalizing such NNs when the output of the NNs is incorrect, an ML model (and specifically, the representations of the nodes in the hidden layer) may be trained (and adjusted) to improve its accuracy and performance in data classification. Adjusting ML models may include adjusting the weights associated with each node in the hidden layer. Thus, the training data may be used as input/output data sets that allow for ML models to make classifications based on input attributes. The operations and components, such as ML models, used to execute workflows for a low latency API gateway are described in further detail below with regard to FIGS. 2-4.

Service applications 122 may correspond to one or more processes to execute modules and associated specialized hardware of service provider system 120 to provide computing services for account usage, digital electronic communications, electronic transaction processing, and the like, which may invoke and/or utilize computing services 131. In this regard, service applications 122 may correspond to specialized hardware and/or software used by service provider system 120 to provide, such as to a user associated with computing device 110, one or more computing services, which in turn utilize computing services 131 and/or other microservices for decision-making during runtime. Service applications 122 may correspond to electronic transaction processing, account, messaging, social networking, media posting or sharing, microblogging, data browsing and searching, online shopping, and other services available through service provider system 120. Service applications 122 may be used by a user to establish an account and/or digital wallet, which may be accessible through one or more user interfaces, as well as view data and otherwise interact with the computing services of service provider system 120. Financial information may be stored to the account, such as account/card numbers and information. A digital token or other account for the account/wallet may be used to send and process payments, for example, through an interface provided by service provider system 120. The payment account may be accessed and/or used through a browser application and/or dedicated payment application, which may provide user interfaces for use of the computing services of service applications 122.

Service applications 122 may be accessed and/or used through a browser application and/or dedicated payment application executed by computing device 110, such as application 112 that displays UIs from service provider system 120. Such account services, account setup, authentication, electronic transaction processing, and other computing services of service applications 122 may utilize computing services 131, such as for gateway orchestration, authentication, electronic transaction processing, risk analysis, fraud detection, and the other decision-making and data processing required by the aforementioned computing services. As such, service applications 122 may handle data processing requests 124 via the computing services 131 provided on computing service architecture 130.

Additionally, service provider system 120 includes database 124. Database 124 may store various identifiers associated with computing device 110. Database 124 may also store account data, including payment instruments and authentication credentials, as well as transaction processing histories and data for processed transactions. Database 124 may include or correspond to a local or distributed database, data store, and/or cloud computing storage system or nodes. Database 124 may be accessed and utilized by orchestration engine 134, such as to retrieve workflows 126 on startup and/or during runtime to handle data processing requests.

Service provider system 120 may include at least one network interface component 128 adapted to communicate computing device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIG. 2 is an exemplary system environment 200 where a gateway of a service provider may provide asynchronous handling of data processing requests using predefined workflows, according to an embodiment. System environment 200 of FIG. 2 includes clients 202 that may be connected with an API gateway 204 for data processing based on data processing requests from clients 202 to gateway services of computing services 131 in computing service architecture 130 of service provider system 120 discussed in reference to system 100 of FIG. 1. In this regard, API gateway 204 may interact with clients 202, such as with or through client-side applications, operating systems, and/or other components and operations of devices including computing device 110, or may instead correspond to other endpoints, devices, servers, and the like that interact with service provider system 120 to request data processing (e.g., service applications 122 that may invoke API gateway 204 during processing of requests.

In system environment 200, on initiation of an interaction and/or request by one or more clients 202 to one or more gateway computing services, those services may invoke and/or utilize API gateway 204 for processing of the requests through workflows 206. Requests may be handled using event handlers and event loops managed from an async web container 208, and core components 210 may provide for functionalities to pick up and process event loops from event handlers in async web container 208 and execute tasks and processing jobs from workflows 206 with computing services 212 (e.g., downstream services including those used for core service provider functionality and computing services, as well as event streaming services, KPI and error logging, and the like). In this regard, clients 202 may request data processing of requests, such as by providing one or more data loads to a computing application, platform, or service that requires action from a service provider. A gateway service may initially receive and/or detect the request and may provide operations for coordinating use of API gateway 204 with computing services 212.

API gateway 204 may be invoked in order to receive and orchestrate processing of the data processing request using workflows 206 and provide a decision or other client response used when responding to clients 202. API gateway 204 may act and/or be a part of an orchestration layer configured to manage network events and other data processing request and/or computing requests. API gateway 204 may processes hundreds of millions of requests per day generated by computing events and other requests from devices (e.g., login attempts, transaction processing, profile visits, etc.). API gateway 204 may utilize a workflow-based approach for handling these events concurrently and responding back with a decision within the agreed SLA. In order to avoid thread contention and memory footprint issues, which impact latency, with a high volume of concurrent requests, API gateway 204 may utilize an orchestration and/or execution engine from core components 210 that executes workflows 206 in a DAG or directed graph-based workflow manner while dynamically managing timeouts. This provides an asynchronous and event-based orchestration engine that may be capable of orchestrating the calls with a minimal number of threads, low memory consumption, and low latency. The engine from core components 210 may utilize both direct memory and heap memory for resource management rather than heap memory alone to avoid critical latency delays in the gateway.

Workflows 206 for each API endpoint of computing services 212 may correspond to a predefined configuration file. Workflows 206 may be parsed and prepared during startup of the gateway application for API gateway 204, which may allow for mitigating additional computational overhead of parsing upon receiving a request. When a request is received at API gateway 204 for a particular API of computing services 212, the predefined workflow for the endpoint may be fetched from the application context and/or in-application memory, for example, based on the request context for execution. Each workflow may be executed in a reactive manner by the engine using the DAG or directed graph-based engine. This engine may schedule the node of the workflow to be executed in an asynchronous manner, for example, using JAVA® CompletableFuture, or other service and engine that allows for chaining together of asynchronous tasks. If all workflows are executed once during application startup for warmup, the downstream connections and services may be warmed up and workflow related classes loaded into heap memory for subsequent handling of the incoming requests.

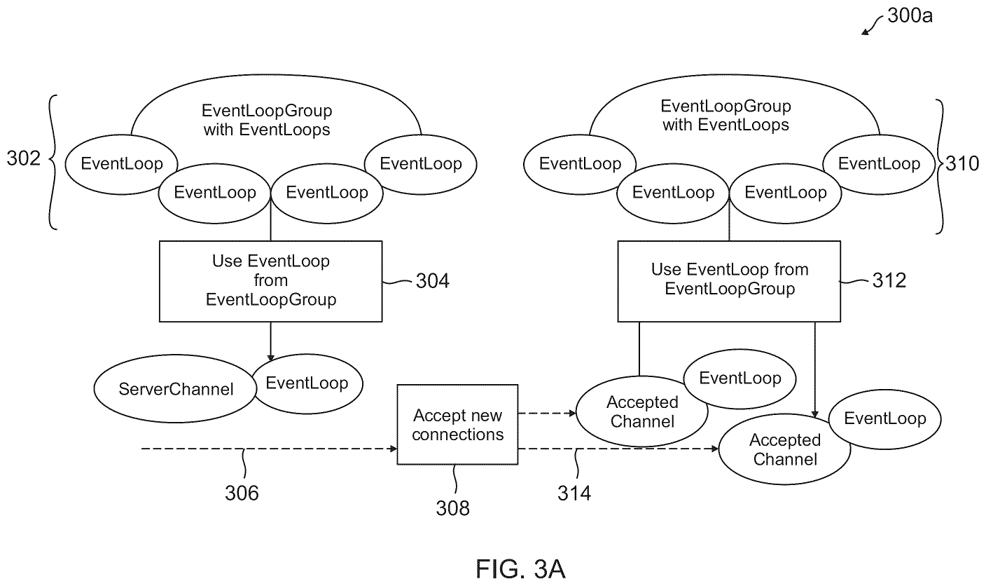

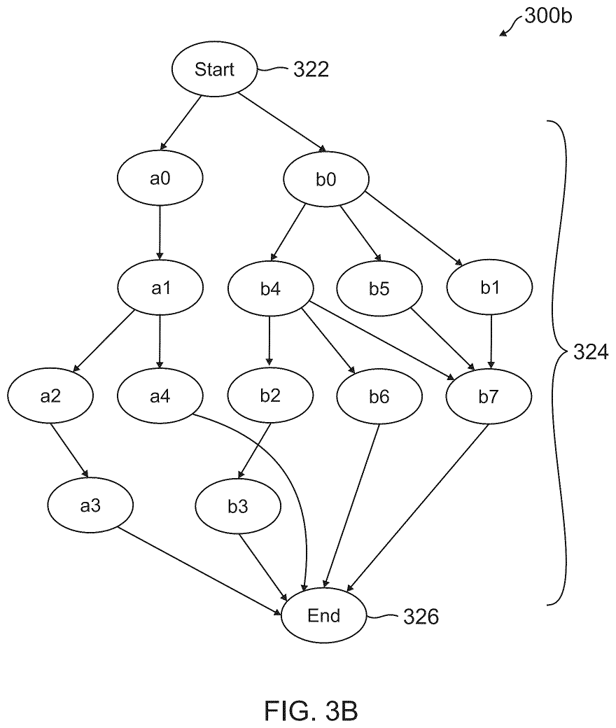

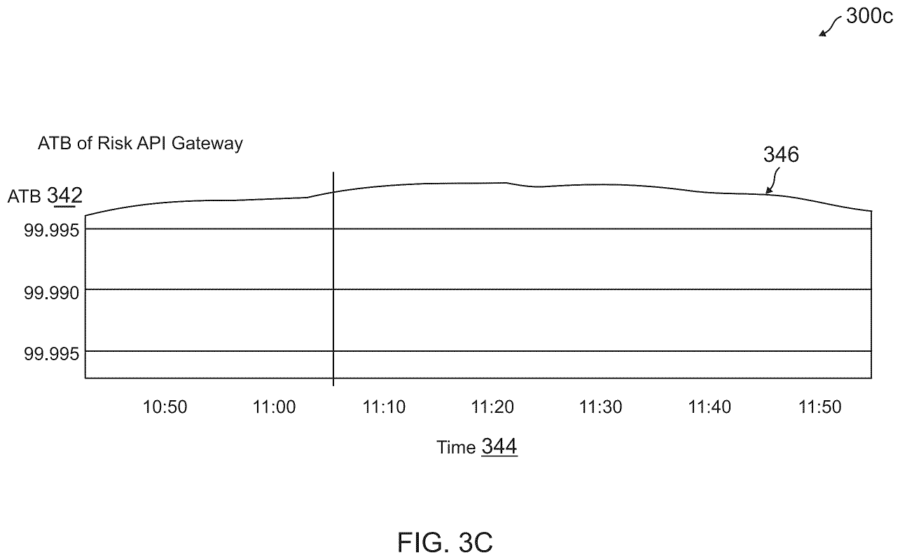

The response of the nodes executed from workflows 206, such as responses from computing services 212, may be handled using a reactive approach as specified by the reactive processing and data streaming specification. The task scheduling algorithm of the orchestration and execution engine may use simple breadth-first search (BFS) algorithmic traversal or other graph traversal technique and may stores all the responses returned for each scheduled task. As such, API gateway 204 may avoid waiting for responses from computing services 212, and the processing thread for the request may then be free to take on and/or execute other tasks. As soon as responses become available, API gateway 204 may be notified using reactive call back methods. As such, all the input/output calls made to the downstream services may be handled internally in a reactive way by using event loops, as shown in FIG. 3A and discussed below. This execution of workflows 206 and processing tasks may therefore cause API gateway 207 to be highly performant and have low latency.

In order to provide a highly configurable gateway and API service for API gateway 204, such as to allow for changes to and/or updating of downstream services, API calls, and the like, workflows 206 may be configurable using predefined nodes and/or custom configured and coded nodes. For example, a workflow generation and/or configuration tool or service may include predefined nodes for common use cases such as invoking downstream services, publishing messages, error handling, logging, filtering, etc. In addition to this, the tool may provide flexibility and the capability to incorporate customized nodes for workflows 206. These nodes allow the users to enhance the functionality by implementing custom logic. For example, if the users want to add the consolidation of responses from multiple downstream services, the user can integrate a custom node and implement consolidation logic. In some embodiments, this may be done by adding conditions to the nodes using expression language expressions or other code statements. The workflow examines the conditions set for a node and proceeds to execute the node after evaluating the specified condition. As such, if computing services 212 undergo changes or new versions becomes available, users can seamlessly transition to the updated services with the data processing nodes of workflows 206 in place of reconfiguring a gateway computing service.

FIGS. 3A-3C are exemplary diagrams 300a-300c for processing of requests using asynchronous calls by a gateway service to downstream computing services, according to an embodiment. Diagrams 300a-300c represent different processes performed by the components of API gateway 132 when coordinating use of downstream services through asynchronous calls and workflow execution. As such, API gateway 132 may utilize workflows 126 with downstream services 133 when receiving requests from clients and other events.

Referring now to FIG. 3A, diagram 300a represents how event loop groups work when bootstrapped for a server. For API gateway 132 to handle many concurrent connections, API gateway 132 may be configured to accept those connections without or with minimal delay and with a minimal use of computing resources. A framework may be utilized with custom configurations for an HTTP server that handles the concurrent connections with a limited number of threads and event loops. For example, the HTTP server may handle an event loop group 302 through a use event loop operation 304 where each event loop from a group is assigned a server channel 306. The server channel 306 is then available for new connections 308 so that other server channels created for event loops from an event loop group 310 may be bound or connected with server channel 306.

As such, the server may be bootstrapped with two event loop groups 302 and 310, which correspond to a pool of single threaded event loops. Each event loop is responsible for handling input/output operations for a corresponding task, such as accepting incoming connections, reading and/or writing data, executing tasks associated with network operations, managing the lifecycle of a channel, etc. When a new request is received, a new channel is created for that request and represents the connection between the client and the server processing the request. As such, any network event to the server is taken up by an event loop and is assigned to one of the channels for further handling. Each channel's behavior may be fine-tuned including adjusting buffer sizes, timeouts, and other settings. As shown in diagram 300a, the service provider may use two event loop groups 302 and 310 to handle different sets of channels such that once server channel 306 is created and new connections 308 are made available, a use event loop operation 312 may bind other event loops from event loop group 310 to the event from event loop group 302 through an accepted channel 314. Thus, the first group contains a channel to bind and listen to the application port while the other group contains all channels which are responsible for handling the accepted connections and incoming requests in those channels.

Referring now to FIG. 3B, diagram 300b includes a workflow having a directed graph, such as a DAG or the like, with multiple corresponding pathways that may be asynchronously executed and/or performed by API gateway 132 execution. For example, a workflow may include a starting node 322, which corresponds to a starting task or operation that may include a call to a downstream decision service to process some data and/or provide a response, such as an initiation of processing of a data load for a request. Starting node 322 may then branch into different pathways 324 each having one or more data processing nodes for separate tasks, where asynchronous calls may be made to downstream computing services based on the tasks or operations to execute at each node in each branch. Each of pathways 324 has corresponding nodes or vertices shown in diagram 300b, where these nodes may correspond to data loads, operations, events, or the like that occur during pathway traversal or execution to provide a resulting output of the strategy. As such, pathways 324 then converge again at an end point 326, which corresponds to a successful strategy execution and an output decision or result of strategy execution by the corresponding decision service.

Referring now to FIG. 3C, diagram 300c shows a monitored KPI, ATB 342, of API gateway 132 by a KPI monitoring process or application over a time 344, which allows for determination of the latency and efficiency of API gateway 132. For example, even a small downtime in the API gateway may adversely affect end users and other clients requesting data processing. ATB values, latency, and/or throughput of the gateway may be important to monitor, such as ATB 342 of gateway 132. As such, the service provider may configure API gateway 132 and the monitoring process to have performance and computing logs to sample request processing times, latency, availability, and the like. As shown in diagram 300c, ATB values 346 may be graphed to show how ATB 342 changes over time 344 and if any maintenance, error resolution, and/or troubleshooting may be required for API gateway 132. ATB values 346 may therefore provide an indication of the gateway's uptime. Other KPIs that may also be monitored may include CPU usage and/or process memory usage to continuously check the performance of API gateway 132.

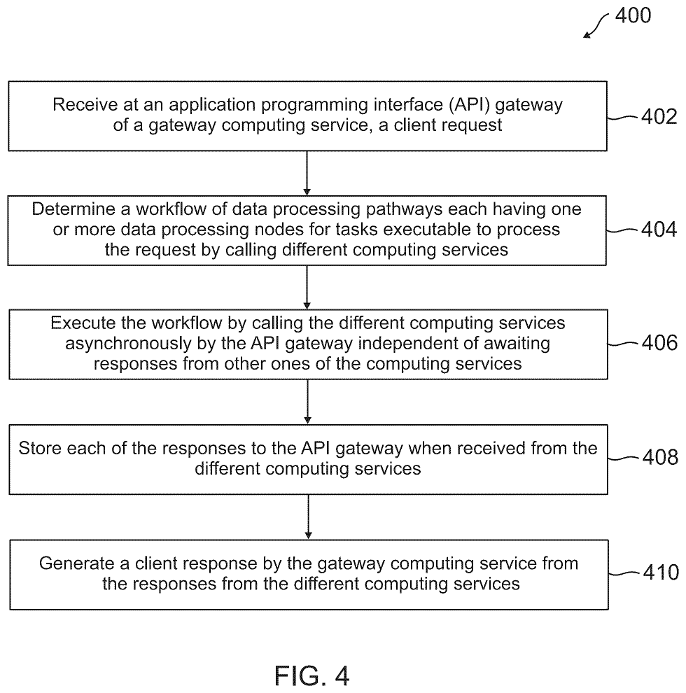

FIG. 4 is a flowchart 400 of an exemplary process for a low latency gateway service for asynchronous handling of data processing requests with downstream computing services, according to an embodiment. Note that one or more steps, processes, and methods described herein of flowchart 400 may be omitted, performed in a different sequence, or combined as desired or appropriate.

Flowchart 400 in FIG. 4 includes steps executed by service provider system 120, such as using API gateway 132 and orchestration engine 134 of computing service architecture 130 to process data processing requests from clients using asynchronous calls to downstream services 133 based on execution of workflows 126.

At step 402 of flowchart 400, a client request is received at an API gateway of a gateway computing service. In this regard, a data processing request may be received at a gateway service of the computing architecture of service provider server 120 and the gateway service may invoke API gateway 132 to handle the request. API gateway 132 may execute and/or invoke orchestration engine 134 to make calls to one or more of downstream services 133 for handling of the requests based on a corresponding one of workflows 126 for the request. In this regard, request 114 may require use of different ones of downstream services 133 for processing based on the data provided to service application 122. API gateway 132 may retrieve, parse, and/or execute workflows 126 on startup and/or at a time prior to receiving the request such as workflows 126 and/or the calls, dependencies, and other information is available from in-application memory and/or have been previously called and are warmed up for data processing (e.g., available and currently executing as an instance of the application and/or service on a server).

At step 404, a workflow of data processing pathways, each having one or more data processing nodes for tasks executable to process the request by calling different computing services, is determined. The gateway computing service may determine one of workflows 126 for the request and may utilize API gateway 132 to perform pathway executions 135 via asynchronous calls to downstream services 133. A downstream service that processes all or portions of the request is determined from the computing services of the computing architecture of the service provider and the corresponding one of workflows 126 matched to the request. For example, based on request 114 and/or corresponding data load or objects for processing, a workflow used to execute tasks with downstream services 133 is determined. The workflow may have multiple different data processing nodes, each assigned to or arranged in a pathway from client request to client response determination. As such, each pathway may be traversed and executed during request processing, which may be done asynchronously by API gateway 132 for faster data processing and more efficient and flexible service usage, updating, and reconfiguring (e.g., adding, deleting, rearranging workflows, etc.).

At step 406, the workflow is executed by calling the different computing services asynchronously by the API gateway independent of awaiting responses from other ones of the computing services. API gateway 132 may determine the calls needed to downstream services 133 based on the data processing nodes in the workflow. Instead of calling the services sequentially and/or awaiting responses from other services, API gateway 132 may perform pathway executions 135 asynchronously so that API gateway 132 may receive responses 136 when available and completed by the corresponding instance of the downstream service. Since downstream services 133 and/or instances of such services have been previously called and/or warmed up from previous workflow parsing and/or execution, responses 136 may be received quickly and a client response to the client request may be determined once sufficient ones of responses 136 are received for proper execution and/or adjudication of the corresponding workflow.

At step 408, each of the responses to the API gateway is stored when received from the different computing services. API gateway 132 may receive responses 136 asynchronously and/or when each response is ready and available from the downstream service, thereby receiving responses prior to other nodes having been completed. As such, API gateway 132 may store responses 136 where a client response to the client request is not yet fulfilled or completed.

At step 410, a client response is generated by the gateway computing service from the responses from the different computing services. Once sufficient ones of responses 136 are received, then a client response may be formulated and determined. This allows for API gateway 132 to provide the response to the corresponding client as quickly as possible when sufficient data is received for adequate completion of the workflow and client response determination. This may include proceeding to generate the client response prior to all pathways and/or nodes in the workflow being processed and/or completed, such as if a response may be determined prior to completion.

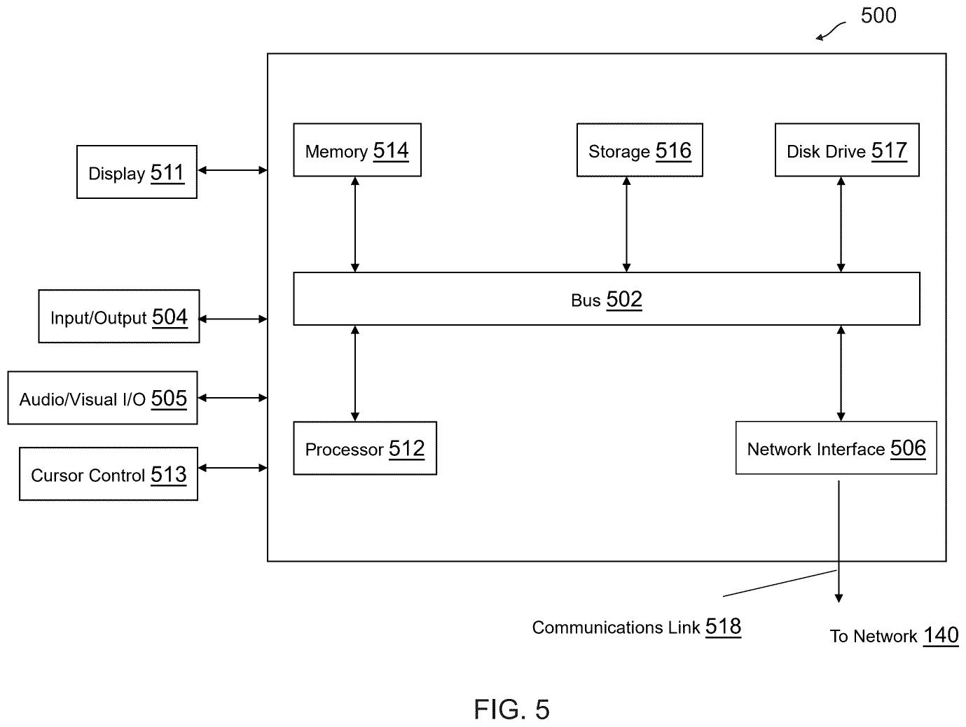

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions from the non-transitory memory to cause the system to:
receive, at an application programming interface (API) gateway of a gateway computing service, a request from a client for a data processing with one or more computing services of a service provider;
create a server channel corresponding to a connection between the client and the one or more computing services;
fetch a workflow having a plurality of data processing nodes each executable for processing the request with the one or more computing services;
parse the workflow for each data processing pathway of the plurality of data processing nodes that processes the request with the one or more computing services;
execute each data processing pathway of the workflow, wherein executing each data processing pathway includes calling, by the API gateway, each of the one or more computing services independent of awaiting one or more responses by other ones of the one or more computing services; and
store, based on executing each data processing pathway, the one or more responses to the API gateway from the one or more computing services.

2. The system of claim 1, wherein the instructions are further executable to cause the system to:
determine that all of the one or more responses or a subset of the one or more responses to the API gateway have been received from the one or more computing services, wherein the subset of the one or more responses enables a client response to be generated;
determine the client response to the request from the client based on all or the subset of the one or more responses; and
respond to the request from the client based on the client response.

3. The system of claim 2, wherein executing each data processing pathway of the workflow is performed asynchronously with each of the one or more computing services, and wherein the instructions are further executable to cause the system to:
receive each of the one or more responses asynchronously; and
process at a next node of the plurality of data processing nodes for a corresponding data processing pathway independent of awaiting additional ones of the one or more responses from the other ones of the one or more computing services.

4. The system of claim 1, wherein the workflow comprises a preconfigured workflow established for the request, and wherein the plurality of data processing nodes in the workflow are configurable based on predefined data processing nodes selectable by a user when creating the preconfigured workflow.

5. The system of claim 4, wherein the preconfigured workflow is represented by a directed graph having the plurality of data processing nodes in each data processing pathway from a start node for initiating the data processing of the request to an end node for responding to the request, and wherein each data processing pathway is configured to be asynchronously processed.

6. The system of claim 1, wherein, prior to fetching the workflow, the instructions are further executable to cause the system to:
attach an event loop to the server channel that is configured to handle input/output operations for the server channel, wherein the input/output operations are associated with executing a corresponding task at each of the plurality of data processing nodes, and wherein the event loop is handled by a network event assigned to the server channel for the data processing of the request.

7. The system of claim 6, wherein the input/output operations are associated with at least one of a connection, reading and/or writing data, or executing tasks associated with the plurality of data processing nodes and/or a lifecycle of the server channels.

8. The system of claim 1, wherein the instructions are further executable to cause the system to:
log data for a plurality of key performance indicators (KPIs) based on executing the corresponding task at each of the plurality of data processing nodes and the one or more responses received from the one or more computing services; and
report the data for tracking of a throughput and a latency of the API gateway.

9. The system of claim 1, wherein the one or more computing services comprise at least one of a risk service, a fraud detection service, a transaction processing service, or a computing decision service, and wherein a server executes one or more instances of the one or more computing services for the data processing of the request via the server channel.

10. A method comprising:
receiving, at an application programming interface (API) of a gateway computing service, a request from a client for data processing with a plurality of computing services of a service provider;
determining a plurality of data processing pathways each having one or more of a plurality of data processing nodes that each correspond to a task for a corresponding one of the plurality of computing services;
executing the plurality of data processing pathways with the plurality of computing services asynchronously independent of awaiting responses by each of the plurality of data processing pathways, wherein the executing includes calling, by the API, each of the plurality of computing services asynchronously;
storing, responsive to the executing, the responses to the API gateway received from the one or more computing services;
determining, at the gateway computing service, a client response to the request based on the responses; and
responding, by the API, to the request with the client response.

11. The method of claim 10, wherein the determining the client response comprises:
determining that each of the plurality of data processing pathways is completed for the request; and
determining the client response from the responses.

12. The method of claim 11, wherein, prior to the storing, the method further comprises:
receiving each of the responses asynchronously from the one or more computing services; and
providing a notification call to the gateway computing service when each of the responses is asynchronously received.

13. The method of claim 10, further comprising:
monitoring a key performance indicator (KPI) of the API; and
reporting the KPI for an analysis of a performance of the API.

14. The method of claim 10, wherein the plurality of data processing pathways correspond to an executable workflow associated with the request, and wherein the determining the plurality of data processing pathways includes identifying the executable workflow based on the request.

15. The method of claim 14, wherein the executable workflow comprises a directed graph having each of the plurality of data processing pathways in a corresponding branch of the directed graph.

16. The method of claim 14, wherein the executable workflow is loaded on a startup of the gateway computing service, and wherein the determining the executable workflow is from an in-application memory of the gateway computing service.

17. The method of claim 14, wherein the plurality of data processing pathways comprise a plurality of data processing nodes each corresponding to a task for execution with the one or more computing services.

18. The method of claim 17, wherein the plurality of data processing nodes include at least one predefined node for a shared task utilized by different computing services across a plurality of computing systems.

19. A non-transitory machine-readable medium having stored thereon machine-readable instructions executable to cause a machine to perform operations comprising:
receiving, at a gateway computing service, a request from a client for data processing with a downstream decision service of a service provider;
determining, for the request, an executable workflow having a plurality of data processing nodes;
executing, by an application programming interface (API) gateway corresponding to the gateway computing service, each of the plurality of data processing nodes with the downstream decision service asynchronously independent of awaiting responses by other ones of the plurality of data processing nodes;
receiving, at the API gateway, the responses from the downstream decision service; and
responding, by the API gateway, to the request based on the responses.

20. The non-transitory machine-readable medium of claim 19, wherein the executable workflow is loaded on a startup of the gateway computing service, and wherein the determining the executable workflow is from an in-application memory of the gateway computing service.
